(19) United States
(12) Patent Application Publication
(10) Pub. No.: US 2010/0208970 A1
(43) Pub. Date: Aug. 19, 2010

(54) Radiographic image capturing system and radiographic image capturing method

(75) Inventors: Masato Hattori, Minami-ashigara-shi (JP); Keiji Tsubota, Minami-ashigara-shi (JP); Yutaka Yoshida, Tokyo (JP); Yasunori Ohta, Yokohama-shi (JP); Naoyuki Nishino, Minami-ashigara-shi (JP)

Correspondence Address: AKERMAN SENTERFITT, 8100 BOONE BOULEVARD, SUITE 700, VIENNA, VA, 22182-2683, US

(73) Assignee: FUJIFILM Corporation, Tokyo (JP)

(21) Appl. No.: 12/656,705

(22) Filed: Feb. 12, 2010

(30) Foreign Application Priority Data
Feb. 16, 2009 (JP) 2009-033211

(51) Int. Cl. G06K 9/00; G01T 1/161

(52) U.S. Cl. 382/132; 250/395; 250/394

(57) ABSTRACT

A radiographic image capturing system includes a plurality of image capturing apparatus for detecting, in a radiographic image capturing process, radiation that has passed through a subject and converting the detected radiation into radiographic image information, and a plurality of consoles for controlling the image capturing apparatus. The radiographic image capturing system also includes an image capture control commander for outputting an image capture control command signal to one of the consoles to enable the console to control the corresponding image capturing apparatus, and an image processing commander for outputting an image processing command signal to at least one of the consoles to enable the console to perform an image processing process to process the radiographic image information from the image capturing apparatus.

### CROSS-REFERENCE TO RELATED APPLICATION

This application is based upon and claims the benefit of priority from Patent Application No. 2009-033211 filed on Feb. 16, 2009, in the Japan Patent Office, of which the contents are incorporated herein by reference.

### BACKGROUND OF THE INVENTION

1. Field of the Invention

The present invention relates to a radiographic image capturing system having one or more image capturing apparatus and a plurality of controllers, as well as to a radiographic image capturing method to be carried out using such a radiographic image capturing system.

2. Description of the Related Art

In the medical field, there have widely been used image capturing apparatus that apply radiation to a subject and guide radiation that has passed through the subject to a radiation detector, which captures a radiographic image from the radiation.

One known radiation detector is a stimulable phosphor panel, which stores radiation energy representative of a radiographic image in a phosphor. When the stimulable phosphor panel is irradiated with stimulating light, the phosphor emits stimulated light representing the stored radiographic image. The stimulable phosphor panel, with the radiographic image recorded therein, is supplied to an image reading apparatus, which reads the stored radiographic image as a visible radiographic image.

Further, in a treatment location such as an operating room or the like, in order to enable processing to be quickly and reliably carried out with respect to a subject (patient), it has been demanded that radiographic image information from a radiation detector be immediately read out and displayed. As a radiation detector capable of meeting this requirement, a radiation detector has been developed that uses solid state image sensors for converting radiation directly into electric signals, or by which, after the radiation has been converted into visible light by a scintillator, the visible light is converted into electric signals, which in turn are read out.

Heretofore, there has been proposed a radiographic image capturing system including a plurality of radiation detectors, which are connected by a network to a plurality of consoles for controlling the radiation detectors and processing radiographic image information detected by the radiation detectors (see, for example, Japanese Laid-Open Patent Publication No. 2006-247137 and Japanese Laid-Open Patent Publication No. 2006-247141). In the proposed radiographic image capturing system, a radiation detector to be used and a console are selected with a keyboard input and are associated with each other on the network. More specifically, the radiation detector is controlled by the corresponding console, and radiographic image information produced by the radiation detector in a radiographic image capturing process is sent to the console via the network.

Each of the radiation detectors of the radiographic image capturing system includes a photoelectric transducer including pixels and amplifiers. Since the pixels and amplifiers have different sensitivities due to manufacturing variations and irregularities, the output characteristics thereof tend to change depending on environmental changes such as temperature and humidity changes, thereby causing artifacts (defects, errors, etc.) in the radiographic image information. According to one solution to this problem, prior to the radiographic image capturing process, offset data of the respective pixels are collected, or sensitivity data of the respective pixels are collected, by applying uniform radiation to the pixels, whereupon a corrective table is generated based on the collected offset data or sensitivity data. Using the corrective table, radiographic image information generated in the radiographic image capturing process is corrected in order to remove sensitivity variations and output characteristic variations of the radiation detectors (see, for example, Japanese Laid-Open Patent Publication No. 2001-286457).

A tomosynthesis image capturing apparatus generates a tomographic image of an area in a region of interest by moving an X-ray tube along a straight track parallel to a detector, or in a circular or elliptical track over the detector such as a flat panel, while applying X-rays from the X-ray tube to a subject at different angles so as to capture a number of radiographic images of the subject. Then, the tomosynthesis image capturing apparatus corrects the radiographic images, and processes the corrected radiographic images in order to reconstruct a tomographic image (see, for example, Japanese Laid-Open Patent Publication No. 2008-043757).

An energy subtraction image capturing apparatus extracts an image (energy subtraction image) of a certain mass of a subject by irradiating the subject with respective sources of radiation having different energy distributions in order to acquire two items of radiographic image information, weighting the items of radiographic image information relative to each other, and subtracting one of the items of radiographic image information from the other in order to generate an energy subtraction image (see, for example, Japanese Laid-Open Patent Publication No. 03-132272).

Radiographic image capturing apparatus that are available in the art include ordinary image capturing apparatus for capturing projected images of subjects, and also tomosynthesis image capturing apparatus and energy subtraction image capturing apparatus of the types referred to above. Radiographic image capturing systems may have one or more image capturing apparatus, along with a single controller for controlling the image capturing apparatus.

According to an energy subtraction image capturing process and a tomosynthesis image capturing process, after a plurality of items of radiographic image information have been corrected, such items need to be subtracted and processed in order to reconstruct a tomographic image. In particular, the tomosynthesis image capturing apparatus needs to perform a time-consuming image processing sequence, because the apparatus usually is required to process seventy or more items of radiographic image information.

If a radiographic image capturing system includes a plurality of image capturing apparatus, one of which is a tomosynthesis image capturing apparatus and others of which are ordinary image capturing apparatus, and a single controller for controlling the image capturing apparatus, then the ordinary image capturing apparatus must be kept idle for a long period, because the correcting process and the reconstructing process for the number of items of radiographic image information generated by the tomosynthesis image capturing apparatus are time-consuming. One solution would be to resort to a special schedule management for operating the tomosynthesis image capturing apparatus with lower priority, and the ordinary image capturing apparatus with higher priority. However, such a schedule management would tend to keep the subject, i.e., a patient, waiting for a long period of time in order to perform the tomosynthesis image capturing process. If an image recapturing process is required, then a complex schedule management would be necessary for a tomosynthesis image capturing process together with an ordinary image capturing process. If an energy subtraction image capturing apparatus is added in the above radiographic image capturing system, then an even more complex schedule management would be required, making it highly likely to complicate the practice of capturing radiographic images.

The above problems hold true for a process of separately capturing a plurality of radiographic images of a wide body region of a subject, such as the entire spine, and then combining (joining) the captured radiographic images into a single image. If stimulable phosphor panels are used, then three stimulable phosphor panels, for example, may be put in an elongate cassette, and a single radiographic image of the entire spine of the subject can be captured using such an elongate cassette. On the other hand, if a radiation detector comprising solid-state image capturing devices is used, then a succession of radiographic images are captured of the entire spine by moving the radiation detector over the entire spine, and then the captured radiographic images are combined into a single wide radiographic image of the entire spine. The process of combining the captured radiographic images is time-consuming, because the captured radiographic images need to be corrected for distortion, and also need to be corrected in position. The process of capturing a succession of radiographic images of the entire spine by moving a radiation detector over the entire spine and combining the captured radiographic images into a single wide radiographic image of the entire spine will hereinafter be referred to as an “elongate image capturing process,” while the apparatus for carrying out the elongate image capturing process shall be referred to as an “elongate image capturing apparatus.”

Similar problems may also occur in a radiographic image capturing system in which ordinary image capturing apparatus are controlled by a single controller. Specifically, the radiographic image capturing system performs a process of replacing a region of captured radiographic image information other than the region of interest with a uniform high density level (or low density level). Such a process will hereinafter be referred to as a “blackening process”. Since such a blackening process is time-consuming, the radiographic image capturing system is unable to capture a subsequent radiographic image while the controller is carrying out the blackening process.

### SUMMARY OF THE INVENTION

It is an object of the present invention to provide a radiographic image capturing system and a radiographic image capturing method for distributing functions and loads with a plurality of controllers in order to operate image capturing apparatus efficiently, thereby facilitating schedule management for a system that includes a single image capturing apparatus and a system that includes various image capturing apparatus connected in a complex layout.

According to an aspect of the present invention, there is provided a radiographic image capturing system comprising at least one image capturing apparatus for detecting radiation that has passed through a subject in a radiographic image capturing process and converting the detected radiation into radiographic image information, one or more controllers for controlling the image capturing apparatus based on image capture command information, a plurality of image processors for performing an image processing process to process the radiographic image information from the image capturing apparatus, an image capture control commanding unit for outputting an image capture control command signal to one of the controllers to enable the one of the controllers to control the image capturing apparatus, and an image processing commanding unit for outputting an image processing command signal to at least one of the image processors to enable the at least one of the image processors to perform the image processing process to process the radiographic image information from the image capturing apparatus.

According to another aspect of the present invention, there is also provided a radiographic image capturing method to be carried out by a radiographic image capturing system including at least one image capturing apparatus for detecting radiation that has passed through a subject in a radiographic image capturing process and converting the detected radiation into radiographic image information, one or more controllers for controlling the image capturing apparatus based on image capture command information, and a plurality of image processors for performing an image processing process to process the radiographic image information from the image capturing apparatus. The radiographic image capturing method comprises the steps of outputting an image capture control command signal to one of the controllers to enable the one of the controllers to control the image capturing apparatus, and outputting an image processing command signal to at least one of the image processors to enable the at least one of the image processors to perform the image processing process to process the radiographic image information from the image capturing apparatus.

The controllers are capable of distributing functions and loads among themselves, thus allowing the image capturing apparatus to operate efficiently. The present invention therefore makes it possible to provide a simplified schedule management for a system including a single image capturing apparatus, as well as for a system including various image capturing apparatus connected in a complex layout.

The image processors may be incorporated respectively in the controllers, and the image processing commanding unit may output the image processing command signal to at least one of the controllers to enable the at least one of the controllers to perform the image processing process to process the radiographic image information from the image capturing apparatus.

The image processors may be incorporated respectively in the controllers, and the image processing commanding unit may output the image processing command signal to at least another one of the controllers, other than the one of the controllers that is supplied with the image capture control command signal.

The image processors may be incorporated respectively in the controllers, and the image processing commanding unit may output the image processing command signal to at least another two of the controllers, other than the one of the controllers that is supplied with the image capture control command signal.

The image processors may be incorporated respectively in the controllers, and the image processing commanding unit may output the image processing command signal to the one of the controllers that is supplied with the image capture control command signal and to at least another one of the controllers.

The image processing commanding unit may instruct at least one of the controllers that are supplied with the image processing command signal, to perform the image processing process to process at least one of a plurality of items of the radiographic image information from the image capturing apparatus, and may instruct at least another one of the controllers that are supplied with the image processing command signal, to perform the image processing to process at least another one of the plurality of items of the radiographic image information from the image capturing apparatus.

The image processors may be incorporated in at least one of the controllers, and the image processing commanding unit may output the image processing command signal to at least one of the image processors incorporated in the at least one of the controllers to enable the at least one of the image processors to perform the image processing process to process the radiographic image information from the image capturing apparatus.

The image processing process performed by the at least one of the image processors may include at least one of:

(1) a correcting process to be carried out on the radiographic image information from the image capturing apparatus;

(2) a blackening process to be carried out on the radiographic image information from the image capturing apparatus;

(3) a subtracting process to be carried out on two items of the radiographic image information from an energy subtraction image capturing apparatus included in the at least one image capturing apparatus;

(4) a process of generating a tomographic image from a plurality of items of the radiographic image information from a tomosynthesis image capturing apparatus included in the at least one image capturing apparatus; and

(5) a process of combining a plurality of items of the radiographic image information from an elongate image capturing apparatus included in the at least one image capturing apparatus, into a radiographic image representative of an elongate area of the subject.

The at least one image capturing apparatus may comprise an energy subtraction image capturing apparatus, the image processing process performed by the image processors that are supplied with the image processing command signal, may comprise a correcting process to be carried out on a plurality of items of the radiographic image information from the image capturing apparatus, and at least one of the image processors may perform a subtracting process on the plurality of items of the radiographic image information on which the correcting process has been carried out.

The at least one image capturing apparatus may comprise a tomosynthesis image capturing apparatus, the image processing process performed by the image processors that are supplied with the image processing command signal, may comprise a correcting process to be carried out on a plurality of items of the radiographic image information from the image capturing apparatus, and at least one of the image processors may perform a process of generating a tomographic image based on the plurality of items of the radiographic image information on which the correcting process has been carried out.

The at least one image capturing apparatus may comprise an elongate image capturing apparatus, the image processing process performed by the image processors that are supplied with the image processing command signal, may comprise a correcting process to be carried out on a plurality of items of the radiographic image information from the image capturing apparatus, and at least one of the image processors may perform a process of combining the plurality of items of the radiographic image information on which the correcting process has been carried out, into a radiographic image representative of an elongate area of the subject.

With the radiographic image capturing system and the radiographic image capturing method according to the present invention, the controllers are capable of distributing functions and loads among themselves, thus allowing the image capturing apparatus to operate efficiently. The present invention therefore makes it possible to provide a simplified schedule management for a system including a single image capturing apparatus, as well as for a system including various image capturing apparatus connected in a complex layout.

The above and other objects, features, and advantages of the present invention will become more apparent from the following description when taken in conjunction with the accompanying drawings in which preferred embodiments of the present invention are shown by way of illustrative example.

### BRIEF DESCRIPTION OF THE DRAWINGS

FIG. 1 is a block diagram of a first system as a radiographic image capturing system according to a first embodiment of the present invention;

FIG. 2 is a block diagram showing configuration details of a host computer of the first system;

FIG. 3 is a circuit diagram, partially in block form, of a radiation detector of an image capturing apparatus of the first system;

FIG. 4 is a block diagram showing configuration details of a communication unit in an image capturing apparatus of the first system;

FIG. 5 is a block diagram showing configuration details of an image capture control system, an image processing system, and a support processing system of a console of the first system;

FIG. 6 is a flowchart of a first processing operation (1) of the first system;

FIG. 7 is a flowchart of a second processing operation (2) of the first system;

FIG. 8 is a flowchart of a processing operation of an ordinary radiographic image capturing process, which is carried out by each control of the first system;

FIG. 9 is a flowchart of a processing operation of an energy subtraction image capturing process, which is carried out by each control of the first system;

FIG. 10 is a flowchart of a processing operation of a tomosynthesis image capturing process, which is carried out by each control of the first system;

FIG. 11 is a block diagram of a second system as a radiographic image capturing system according to a second embodiment of the present invention;

FIG. 12 is a vertical cross-sectional view of an image reading apparatus of the second system;

FIG. 13A is a block diagram showing a command system of a radiographic image capturing system according to an embodiment of the present invention;

FIG. 13B is a block diagram showing a command system of a radiographic image capturing system according to a first modification of the present invention;

FIG. 14A is a block diagram showing a command system of a radiographic image capturing system according to a second modification of the present invention; and

FIG. 14B is a block diagram showing a command system of a radiographic image capturing system according to a third modification of the present invention.

### DESCRIPTION OF THE PREFERRED EMBODIMENTS

Like or corresponding parts are denoted by like or corresponding reference characters throughout the views.

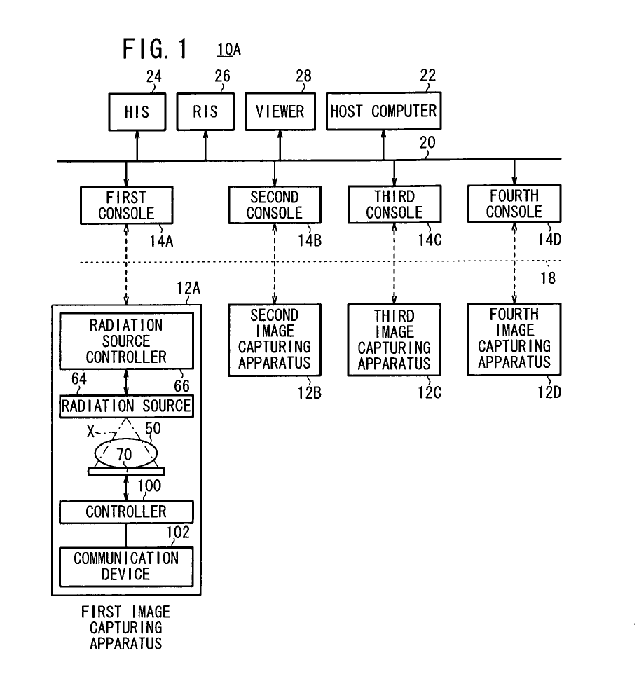

Radiographic image capturing systems and radiographic image capturing methods according to preferred embodiments of the present invention will be described below with reference to FIGS. 1 through 14B.

As shown in FIG. 1, a radiographic image capturing system according to a first embodiment of the present invention (hereinafter referred to as a “first system 10A”) comprises four image capturing apparatus (a first image capturing apparatus 12A, a second image capturing apparatus 12B, a third image capturing apparatus 12C, and a fourth image capturing apparatus 12D) each having a radiation detector for detecting, in a radiographic image capturing process, radiation that has passed through a subject and converting the detected radiation into radiographic image information, and a plurality of controllers (a first console 14A, a second console 14B, a third console 14C, and a fourth console 14D) for controlling the first through fourth image capturing apparatus 12A through 12D based on image capture command information supplied from an external source. The first through fourth consoles 14A through 14D are associated respectively with the first through fourth image capturing apparatus 12A through 12D.

The first through fourth image capturing apparatus 12A through 12D and the first through fourth consoles 14A through 14D are connected to each other by a wireless network, i.e., a wireless LAN 18, indicated by the broken line. The first through fourth consoles 14A through 14D are connected to a wired network, i.e., a wired LAN 20, which is connected to a host computer 22 for managing and controlling the first through fourth consoles 14A through 14D, a hospital information system (HIS) 24 for managing medical information in a hospital, a radiology information system (RIS) 26 for managing a process of capturing radiographic images in the radiological department of the hospital under management of the HIS 24, and a viewer 28 for allowing a doctor to interpret captured radiographic images.

The host computer 22 acquires, via the wired LAN 20, patient information including the name, age, gender, etc., of a patient, which have been set using the HIS 24, and image capture command information including a radiographic image capturing method, a region to be imaged, and an image capturing apparatus to be used for the patient, which have been set by the doctor or a radiological technician using the RIS 26. If necessary, the image capture command information may comprise image capturing conditions including a tube voltage, a tube current, and a radiation applying time, etc., which are to be set in the radiation source of the image capturing apparatus that is used. The host computer 22 supplies the acquired patient information and image capture command information to corresponding ones of the first through fourth consoles 14A through 14D via the wired LAN 20.

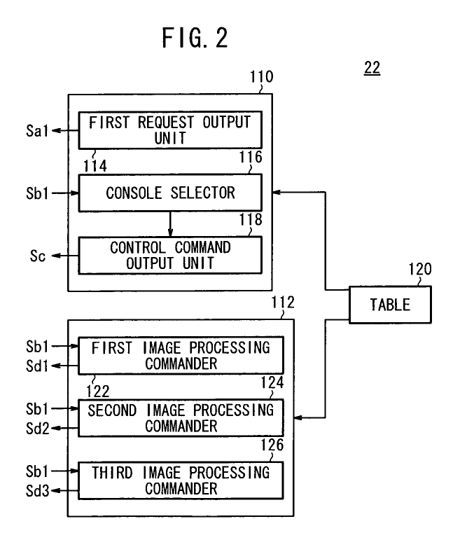

As shown in FIG. 2, the host computer 22 includes an image capture control commander (image capture control commanding unit) 110 and an image processing commander (image processing commanding unit) 112.

The image capture control commander 110 comprises a first request output unit 114 for outputting a first request signal Sa1 to the first through fourth consoles 14A through 14D at a time when the host computer 22 is supplied with an input signal for using either one of the image capturing apparatus, or when the host computer 22 has automatically identified either one of the image capturing apparatus to be used based on the patient information, a console selector 116 for selecting one from among one or more consoles that have sent a first answer signal Sb1 in response to the first requests signal Sa1, and a control command output unit 118 for outputting an image capture control command signal Sc to the selected console. The image capture control command signal Sc is sent along with the ID of the image capturing apparatus to be controlled.

More specifically, when the operator of the first system 10A uses either one of the first through fourth image capturing apparatus 12A through 12D, the host computer 22 outputs the image capture control command signal Sc to one of the first through fourth consoles 14A through 14D, which is directly associated with the image capturing apparatus to be used. For example, when the operator intends to use the first image capturing apparatus 12A, then the host computer 22 normally outputs the image capture control command signal Sc to the first console 14A, which is directly associated with the first image capturing apparatus 12A. However, if the first console 14A is currently in the process of processing radiographic image information, then the host computer 22 outputs the image capture control command signal Sc to another console, which is not currently occupied with processing radiographic image information. At this time, the host computer 22 selects one of the consoles using a priority table 120. The priority table 120 includes IDs of the first through fourth consoles 14A through 14D registered sequentially therein. If the first console 14A is currently in the process of processing radiographic image information, then the host computer 22 confirms the second console 14B. If the second console 14B is not currently processing radiographic image information, then the host computer 22 selects the second console 14B. The console, which has received the image capture control command signal Sc from the host computer 22, sends its own console information Db (an ID or the like) to the image capturing apparatus (e.g., the first image capturing apparatus 12A), which is to be controlled thereby.

The image processing commander 112 comprises a first image processing commander 122, a second image processing commander 124, and a third image processing commander 126. Using the priority table 120, the image processing commander 112 selects one or more consoles to be used for processing radiographic image information from among one or more consoles, other than the console to which the image capture control command signal Sc has been supplied.

If the image capturing apparatus to be controlled is an ordinary image capturing apparatus, i.e., the image capturing apparatus is neither a tomosynthesis image capturing apparatus nor an energy subtraction image capturing apparatus nor an elongate image capturing apparatus, then the first image processing commander 122 outputs a first image processing command signal Sd1 to one console, which has not been selected by the console selector 116, among two or more consoles which have sent the first answer signal Sb1.

If the image capturing apparatus to be controlled is an energy subtraction image capturing apparatus, then the second image processing commander 124 outputs a second image processing command signal Sd2 to one or two consoles, which have not been selected by the console selector 116, among one or more consoles that have sent the first answer signal Sb1.

The second image processing command signal Sd2 is sent along with number information of the radiographic image information Da to be corrected and the ID of a console to carry out a subtracting process. For example, if the second image processing command signal Sd2 is output to only one console, then it is sent along with “0” as the number information and the ID of the console. The number information “0” represents a correcting process for two items of radiographic image information Da. If the second image processing command signal Sd2 is output to two consoles, then on the assumption that one of the consoles carries out a subtracting process, the second image processing command signal Sd2 is sent to that console along with “1” as the number information and the ID of the one of the consoles, and the second image processing command signal Sd2 is sent to the other console along with “2” as the number information and the ID of the one of the consoles. The number information “1” represents a correcting process for the first one of the two items of radiographic image information Da, and the number information “2” represents a correcting process for the second one of the two items of radiographic image information Da. After the correcting process for the first one of the two items of radiographic image information Da in the one console, and the correcting process for the second one of the two items of radiographic image information Da in the other console, have been completed, the other console transfers the corrected second one of the two items of radiographic image information Da to the one console. Thereafter, the one console performs a subtracting process on the corrected two items of radiographic image information Da, to thereby generate an energy subtraction image.

If the image capturing apparatus to be controlled is a tomosynthesis image capturing apparatus or an elongate image capturing apparatus, then the third image processing commander 126 outputs a third image processing command signal Sd3 to one or more consoles, which have not been selected by the console selector 116, among one or more consoles that have sent the first answer signal Sb1.

The third image processing command signal Sd3 is sent along with number information of the radiographic image information Da to be corrected and the ID of a console to carry out a reconstructing process (a process of generating a tomographic image) or a combining process. For example, if the third image processing command signal Sd3 is output to only one console, then it is sent along with “0” as the number information, “1” as the number of consoles, and the ID of the console. The number information “0” represents a correcting process for all items of radiographic image information Da. If the third image processing command signal Sd3 is output to two consoles, then on the assumption that one of the consoles carries out a reconstructing process or a combining process, the third image processing command signal Sd3 is sent to that console along with “1” as the number information, “2” as the number of consoles, and the ID of that one of the consoles, and the third image processing command signal Sd3 is sent to the other console along with “2” as the number information, “2” as the number of consoles, and the ID of that one of the consoles. The number information “1” represents a correcting process for an odd-numbered item of radiographic image information Da, whereas the number information “2” represents a correcting process for an even-numbered item of radiographic image information Da. After the correcting process for the odd-numbered item of radiographic image information Da in one of the consoles, and the correcting process for the even-numbered item of radiographic image information Da in the other console, have been completed, the other console transfers the corrected even-numbered item of radiographic image information Da along with the number information and the console ID to the one console. Thereafter, the one console performs a reconstructing process or a combining process on all of the corrected items of radiographic image information Da, to thereby generate a tomographic image of a region of interest or a wide radiographic image of the spine or the like from the host computer 22.

Similarly, if the third image processing command signal Sd3 is output to three consoles, e.g., the second console 14B, the third console 14C, and the fourth console 14D, then on the assumption that the second console 14B carries out a reconstructing process or a combining process, the third image processing command signal Sd3 is sent to the second console 14B along with “1” as the number information, “3” as the number of consoles, and the ID of the second console 14B, the third image processing command signal Sd3 is sent to the third console 14C along with “2” as the number information, “3” as the number of consoles, and the ID of the second console 14B, and the third image processing command signal Sd3 is sent to the fourth console 14D along with “3” as the number information, “3” as the number of consoles, and the ID of the second console 14B. The number information “1” represents a correcting process for a (3n+1)th (n=0, 1, 2, . . . ) item of radiographic image information Da, the number information “2” represents a correcting process for a (3n+2)th item of radiographic image information Da, and the number information “3” represents a correcting process for a (3n+3)th item of radiographic image information Da. Accordingly, in a tomosynthesis image capturing process or an elongate image capturing process, radiographic image information is distributed to consoles according to the relationship An (n=0, 1, 2, . . . )+m (m=1, 2, 3, . . . ), where A represents the number of consoles. After the correcting process for the (3n+1)th item of radiographic image information Da in the second console 14B, the correcting process for the (3n+2)th item of radiographic image information Da in the third console 14C, and the correcting process for the (3n+3)th item of radiographic image information Da in the fourth console 14D have been completed, the corrected (3n+2)th item of radiographic image information Da from the third console 14C is sent along with the number information and the console ID to the second console 14B, whereas the corrected (3n+3)th item of radiographic image information Da from the fourth console 14D is sent along with the number information and the console ID to the second console 14B. Thereafter, the second console 14B arranges all of the corrected items of radiographic image information Da in chronological order based on the number information and the console IDs, in order to generate a tomographic image of a region of interest or a wide radiographic image of the spine or the like from the host computer 22.

As shown in FIG. 1, the first image capturing apparatus 12A comprises an upstanding image capturing apparatus or a recumbent image capturing apparatus for capturing a radiographic image of the chest or the like of a subject 50. The first image capturing apparatus 12A comprises a radiation source 64 controlled by a radiation source controller 66, an image capturing base (not shown) housing therein a radiation detector 70, which is made up of solid-state image capturing devices disposed in confronting relation to the radiation source 64, a controller 100 for controlling the radiation detector 70, and a communication device 102 for communicating with either one of the first through fourth consoles 14A through 14D. The radiation source controller 66 controls the radiation source 64 according to image capturing conditions that are set by the first console 14A. The second through fourth image capturing apparatus 12B through 12D are similar in structure to the first image capturing apparatus 12A, and will not be described in detail below.

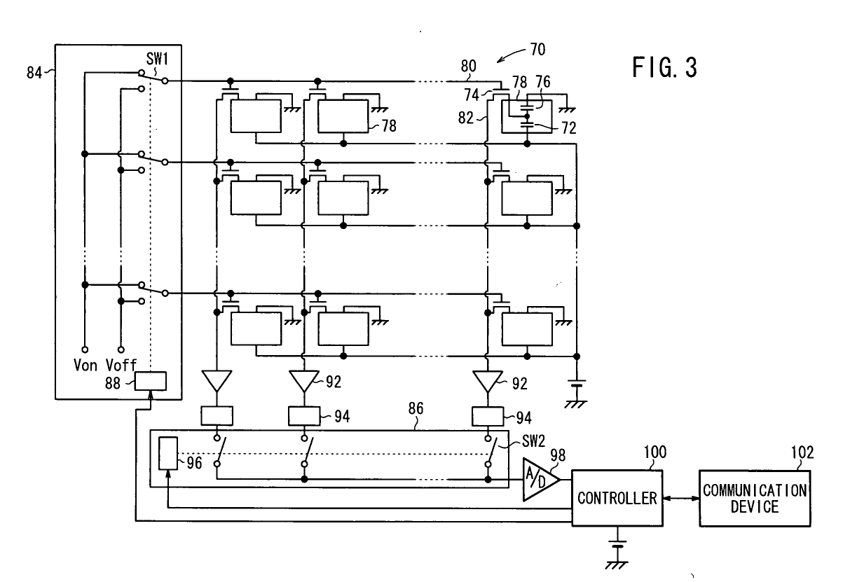

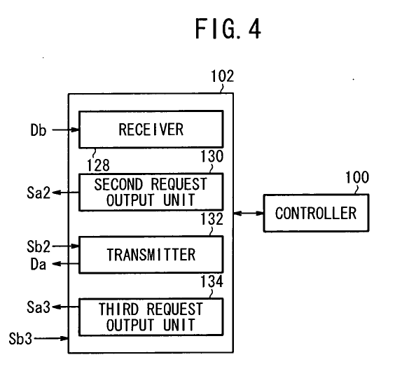

As shown in FIG. 3, the radiation detector 70 comprises an array of thin-film transistors (TFTs) 74 arranged in rows and columns, a photoelectric conversion layer 72 made of a material such as amorphous selenium (a-Se) for generating electric charges upon detection of radiation, the photoelectric conversion layer 72 being disposed on the array of TFTs 74, and an array of storage capacitors 76 connected to the photoelectric conversion layer 72. When radiation is applied to the radiation detector 70, the photoelectric conversion layer 72 generates electric charges, and the storage capacitors 76 store the generated electric charges. Then, the TFTs 74 are turned on one row at a time in order to read the electric charges from the storage capacitors 76 as an image signal. In FIG. 4, the photoelectric conversion layer 72 and one of the storage capacitors 76 are shown as forming a pixel 78, wherein the pixel 78 is connected to one of the TFTs 74. Details of other pixels 78 have been omitted from illustration. Since amorphous selenium tends to change in structure and lose functionality at high temperatures, amorphous selenium needs to be used within a certain temperature range. Therefore, some means for cooling the radiation detector 70 should preferably be provided in the image capturing base.

The TFTs 74 connected to the respective pixels 78 are connected to respective gate lines 80 extending parallel to the rows, and to respective signal lines 82 extending parallel to the columns. The gate lines 80 are connected to a line scanning driver 84, and the signal lines 82 are connected to a multiplexer 86 that serves as a reading circuit.

The gate lines 80 are supplied with control signals Von, Voff for turning on and off the TFTs 74 along the rows from the line scanning driver 84. The line scanning driver 84 comprises a plurality of switches SW1 for switching between the gate lines 80, and an address decoder 88 for outputting a selection signal for selecting one of the switches SW1 at a time. The address decoder 88 is supplied with an address signal from a controller 100.

The signal lines 82 are supplied with electric charges stored in the storage capacitors 76 of the pixels 78 through the TFTs 74 arranged in the columns. The electric charges supplied to the signal lines 82 are amplified by amplifiers 92 connected respectively to the signal lines 82. The amplifiers 92 are connected through respective sample and hold circuits 94 to the multiplexer 86. The multiplexer 86 comprises a plurality of switches SW2 for successively switching between the signal lines 82, and an address decoder 96 for outputting a selection signal for selecting one of the switches SW2 at a time. The address decoder 96 is supplied with an address signal from the controller 100. The multiplexer 86 has an output terminal connected to an A/D converter 98. A radiographic image signal generated by the multiplexer 86 based on the electric charges from the sample and hold circuits 94 is converted by the A/D converter 98 into digital image signals representing the radiographic image information, which are supplied to the communication device 102. The communication device 102 supplies the acquired radiographic image information through the wireless LAN 18 to either one of the first through fourth consoles 14A through 14D. In this manner, the communication device 102 establishes a communication link with a console that is specified by the host computer 22, and sends the obtained radiographic image information through the established communication link to the specified console.

More specifically, the communication device 102 includes a receiver 128 for receiving the information Db from a console, a second request output unit 130 for outputting a second request signal Sa2 for requesting a console represented by a received console ID to establish a communication link prior to the transmission of radiographic image information Da, and a transmitter 132 for transmitting the radiographic image information Da to the console upon reception of a second answer signal Sb2 sent from the console in response to the second request signal Sa2. The transmitter 132 sends the radiographic image information Da along with an ID code Dc of the image capturing apparatus.

The communication device 102 also includes a third request output unit 134 for outputting a third request signal Sa3 for requesting the console to cancel the communication link when transmission of the radiographic image information Da is finished. When the communication device 102 receives a third answer signal Sb2 sent from the console in response to the third request signal Sa3, the communication process between the image capturing apparatus and the console is terminated.

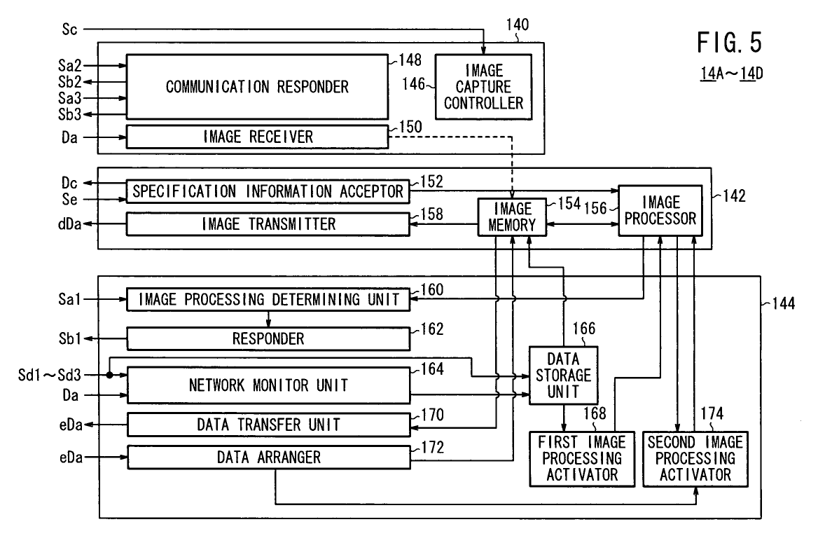

As shown in FIG. 5, each of the first through fourth consoles 14A through 14D generally comprises an image capture control system 140, an image processing system 142, and a support processing system 144.

The image capture control system 140 comprises an image capture controller 146 for controlling an image capturing apparatus, which is identified by the ID sent along with the image capture control command signal Sc when the image capture control command signal Sc is received from the host computer 22, a communication responder 148 for outputting the second answer signal Sb2 based on reception of the second request signal Sa2 from the communication device 102 of the controlled image capturing apparatus for thereby starting a communication process with the controlled image capturing apparatus, and also for outputting the third answer signal Sb3 based on reception of the third request signal Sa3 from the communication device 102 for thereby terminating the communication process with the controlled image capturing apparatus, and an image receiver 150 for receiving radiographic image information Da from the controlled image capturing apparatus. The image receiver 150 receives the radiographic image information Da from the image capturing apparatus, in order to enable the other consoles to monitor the radiographic image information Da via the network. Therefore, the image receiver 150 does not store the received radiographic image information Da, but rather erases the received radiographic image information Da. In other words, the console, which has received the image capture control command signal Sc, does not perform an image processing process.

The image processing system 142 comprises a specification information acceptor 152 for sending the received ID code Dc of an image capturing apparatus to the host computer 22, and for accepting specification information Se (including a corrective table, whether there is a blackening process or not, an address of a region of interest, the sequence of a combining process, whether there is a subtracting process or not, etc.) corresponding to the ID code Dc of the image capturing apparatus from the host computer 22, an image memory 154 for storing the received radiographic image information Da, an image processor 156 for performing an image processing process depending on the accepted specification information Sd concerning the radiographic image information Da stored in the image memory 154, and an image transmitter 158 for sending processed radiographic image information dDa along with the ID code Dc of the image capturing apparatus to the host computer 22. The image processing process carried out by the image processor 156 may be a process for correcting the radiographic image information Da based on the received corrective table, as well as a process for replacing a region of the corrected radiographic image information apart from the region of interest with a uniform high density level (or low density level), i.e., a blackening process. If a tomosynthesis image capturing process is carried out, then the image processing process may also be a process for processing a number of items of radiographic image information Da in order to reconstruct a tomographic image of a region of interest. If an elongate image capturing process is carried out, then the image processing process may also be a process for combining a number of items of radiographic image information Da in order to generate a wide radiographic image of the spine or the like of a subject. If an energy subtraction image capturing process is carried out, then the image processing process may also be a process for performing a subtracting process on two items of radiographic image information Da in order to generate an energy subtraction image. The processed radiographic image information dDa, which is sent to the host computer 22, also is sent to the viewer 28 through the wired LAN 20. The doctor then interprets for diagnosis the radiographic image displayed by the viewer 28 based on the radiographic image information dDa. Each of the first through fourth consoles 14A through 14D may include a display unit for displaying both the unprocessed radiographic image information Da as well as the processed radiographic image information dDa.

The support processing system 144 comprises an image processing determining unit 160 for determining whether or not an image processing process is possible, i.e., whether the image processor 156 is currently in the midst of carrying out an operation, based on reception of the first request signal Sa1 from the host computer 22, a responder 162 for sending the first answer signal Sb1 to the host computer 22 if the image processor 156 is not currently performing an operation, i.e., if an image processing process is possible, a network monitor unit 164 for monitoring the wireless LAN 18 and reading the radiographic image information Da sent via the wireless LAN 18 based on input of any one of the first image processing command signal Sd1 through the third image processing command signal Sd3, a data storage unit 166 for storing in the image memory 154 radiographic image information Da, which corresponds to the attribute (number information) of the supplied one of the first image processing command signal Sd1 through the third image processing command signal Sd3, a first image processing activator 168 for activating the image processor 156 in order to perform a corrective process on one or more items of radiographic image information Da stored in the image memory 154 when the data storage unit 166 has finished storing the radiographic image information Da in the image memory 154, a data transfer unit 170 for transferring one or more items of corrected radiographic image information eDa to a console, which corresponds to the specified ID, when the second image processing command signal Sd2 or the third image processing command signal Sd3 is received, a data arranger 172 for storing corrected radiographic image information eDa from another console sequentially in the image memory 154 if the console thereof is a console that corresponds to the specified ID, and a second image processing activator 174 for activating the image processor 156 in order to perform a blackening process, a subtracting process, or a reconstructing process on the corrected radiographic image information eDa stored in the image memory 154, when the corrective process carried out by the image processor is completed or once the data arranger 172 has finished arranging the corrected radiographic image information eDa.

If the transferred radiographic image information eDa is radiographic image information generated during the energy subtraction image capturing process, then the data arranger 172 stores the transferred radiographic image information eDa in a sequence that matches a subtracting process to be subsequently carried out on the radiographic image information eDa corrected in the console. If the transferred radiographic image information eDa is radiographic image information generated during the tomosynthesis image capturing process or during the elongate image capturing process, then the data arranger 172 arranges the transferred radiographic image information eDa in chronological order along with the radiographic image information eDa corrected in the console, based on the number information and the console ID added to each item of radiographic image information eDa.

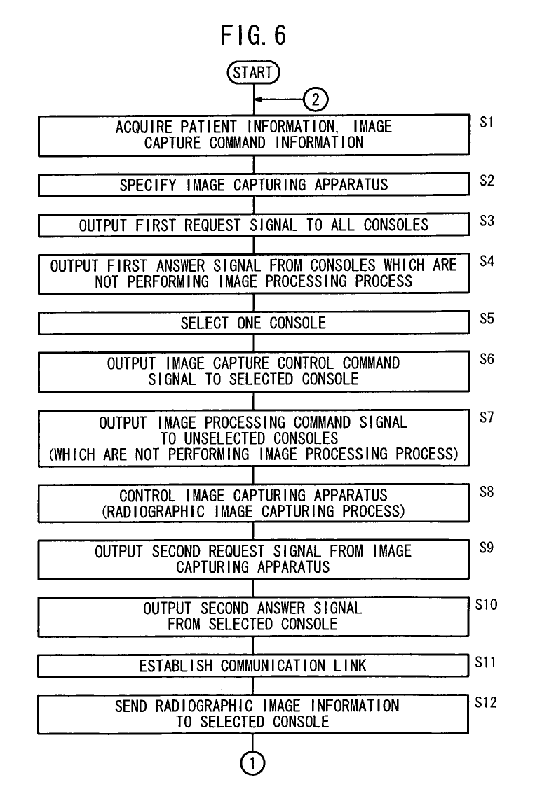

Operation of the first system will be described below with reference to FIGS. 6 through 10.

As shown in FIG. 6, in step S1, the host computer 22 acquires patient information and image capture command information. Specifically, patient information including the name, age, gender, etc., of a patient is set using the HIS 24, and image capture command information including a radiographic image capturing method, a region to be imaged, and an image capturing apparatus to be used for the patient, is set in relation to the patient information using the RIS 26. The host computer 22, which is installed in the radiological department of the hospital, acquires the patient information and the image capture command information from the RIS 26 via the wired LAN 20.

Then, in step S2, the host computer 22 specifies one, e.g., the first image capturing apparatus 12A, of the first through fourth image capturing apparatus 12A through 12D, which corresponds to the patient information and the image capture command information.

Then, in step S3, the first request output unit 114 of the image capture control commander 110 outputs a first request signal Sa1 to the first through fourth consoles 14A through 14D.

Based on the first request signal Sa1 output from the host computer 22, the image processing determining unit 160 (see FIG. 5) of each of the first through fourth consoles 14A through 14D determines whether an image processing process is possible or not, i.e., whether the image processor 156 is currently in the midst of carrying out an operation or not. Any console whose image processor 156 is determined to be in the midst of performing an operation waits until the image processor 156 thereof completes the current operation, because another image processing process is not yet possible.

If the image processor 156 of any console is determined not to be in the midst of carrying out an operation, then control goes to the next step, since an image capture control process or an image processing process can be performed thereby. For example, if all of the first through fourth consoles 14A through 14D are capable of performing an image capture control process or an image processing process, then control proceeds to step S4, in which the responder 162 (see FIG. 5) of each of the first through fourth consoles 14A through 14D sends a first answer signal Sb1 to the host computer 22.

In response to the first answer signal Sb1 sent to the host computer 22, in step S5, the console selector 116 (see FIG. 2) selects one of the first through fourth consoles 14A through 14D, which have sent the first answer signal Sb1. At this time, the console selector 116 selects one of the first through fourth consoles 14A through 14D according to the sequence in which the consoles are registered in the priority table 120. It is assumed that the console selector 116 selects the first console 14A, for example.

In step S6, the control command output unit 118 of the host computer 22 outputs an image capture control command signal Sc to the selected console 14A.

In step S7, using the priority table 120, the image processing commander 112 selects one or more consoles to carry out an image processing process, from among one or more of the consoles apart from the first console 14A to which the image capture control command signal Sc has been supplied.

Specifically, if the image capturing apparatus controlled by the first console 14A, to which the image capture control command signal Sc has been supplied, is an ordinary image capturing apparatus, then the first image processing commander 122 outputs a first image processing command signal Sd1 to one console, which has not been selected by the console selector 116. If the image capturing apparatus controlled by the first console 14A is an energy subtraction image capturing apparatus, then the second image processing commander 124 outputs a second image processing command signal Sd2 to one or two consoles, which have not been selected by the console selector 116. Similarly, if the image capturing apparatus controlled by the first console 14A is a tomosynthesis image capturing apparatus or an elongate image capturing apparatus, the third image processing commander 126 outputs a third image processing command signal Sd3 to one or more consoles, which have not been selected by the console selector 116.

In step S8, upon reception of the image capture control command signal Sc from the host computer 22, the image capture controller 146 of the first console 14A controls the image capturing apparatus, e.g., the first image capturing apparatus 12A, which corresponds to the ID added to the image capture control command signal Sc. In other words, the first console 14A, to which the patient information and the image capture command information have been sent, performs a process for capturing a radiographic image of the patient with the first image capturing apparatus 12A under its own control, according to the image capture command information.

A specific process for capturing a radiographic image of the subject 50, which is carried out by the first image capturing apparatus 12A under the control of the first console 14A, will be described below with reference to FIG. 1. When the first console 14A receives patient information and image capture command information from the host computer 22, the first console 14A sets a tube voltage, a tube current, and a radiation applying time, which are represented by the image capturing conditions included in the image capture command information, in the radiation source controller 66 of the first image capturing apparatus 12A.

After the subject 50 has been positioned in a prescribed position on the image capturing base, the radiological technician operates an exposure switch (not shown) to begin the radiographic image capturing process. The radiation source controller 66 controls the radiation source 64 according to the image capturing conditions set therein, so as to apply radiation X to the subject 50. Radiation X, which has passed through the subject 50, irradiates the radiation detector 70.

The radiation X is converted into electric signals by the photoelectric conversion layer 72 of the pixels 78 of the radiation detector 70 (FIG. 3). The electric signals are stored as electric charges in the storage capacitors 76. The stored electric charges, which represent radiographic image information of the subject 50, are read from the storage capacitors 76 according to address signals, which are supplied from the controller 100 to the line scanning driver 84 and the multiplexer 86.

More specifically, in response to the address signal supplied from the controller 100, the address decoder 88 of the line scanning driver 84 outputs a selection signal to select one of the switches SW1, which supplies the control signal Von to the gates of the TFTs 74 connected to the gate line 80 corresponding to the selected switch SW1. In response to the address signal supplied from the controller 100, the address decoder 96 of the multiplexer 86 outputs a selection signal to successively turn on the switches SW2 to switch between the signal lines 82, for thereby reading through the signal lines 82 the electric charges stored in the storage capacitors 76 of the pixels 78 connected to the selected gate line 80.

The electric charges read from the storage capacitors 76 of the pixels 78 connected to the selected gate line 80 are amplified by the respective amplifiers 92, sampled by the sample and hold circuits 94, and supplied to the multiplexer 86. Based on the supplied electric charges, the multiplexer 86 generates and supplies a radiographic image signal to the A/D converter 98, which converts the radiographic image signal into digital signals.

Similarly, the address decoder 88 of the line scanning driver 84 successively turns on the switches SW1 to switch between the gate lines 80 according to the address signal supplied from the controller 100. The electric charges stored in the storage capacitors 76 of the pixels 78 connected to the successively selected gate lines 80 are read through the signal lines 82, and processed by the multiplexer 86 and the A/D converter 98 into digital signals.

The radiographic image information represented by the digital signals is transmitted from the communication device 102 to the first console 14A.

In step S9, as shown in FIG. 6, the second request output unit 130 (see FIG. 4) of the communication device 102 sends a second request signal Sa2 for requesting establishment of a communication link with the console (the first console 14A), to which the image capture control command signal Sc has been supplied.

In step S10, based on the second request signal Sa2 from the first image capturing apparatus 12A, the communication responder 148 (see FIG. 5) of the first console 14A sends a second answer signal Sb2 to the source of the second request signal Sa2 (i.e., to the first image capturing apparatus 12A).

In step S11, when the second answer signal Sb2 sent from the first console 14A is received by the communication device 102 of the first image capturing apparatus 12A, a communication link is established between the first image capturing apparatus 12A and the first console 14A. Thereafter, in step S12, the transmitter 132 of the communication device 102 of the first image capturing apparatus 12A sends the radiographic image information Da in digital form along with the ID code Dc of the first image capturing apparatus 12A to the first console 14A through the established communication link. At this time, one item of radiographic image information Da is sent to the first console 14A in an ordinary radiographic image capturing process, which is neither the tomosynthesis image capturing process, the energy subtraction image capturing process, nor the elongate image capturing process. Further, two items of radiographic image information Da are sent to the first console 14A in the energy subtraction image capturing process, several tens of items of radiographic image information Da are sent to the first console 14A in the tomosynthesis image capturing process, and several items of radiographic image information Da are sent to the first console 14A in the elongate image capturing process.

The image receiver 150 of the first console 14A receives the radiographic image information Da together with additional data. However, the image receiver 150 does not store the received radiographic image information Da and the additional data in the image memory 154, but rather erases such information and data. In other words, the first console 14A does not perform an image processing process on the received radiographic image information Da.

The second through fourth consoles 14B through 14D, to which the image capture control command signal Sc has not been supplied, but which are supplied with the first image processing command signal Sd1 through the third image processing command signal Sd3, operate respectively as follows:

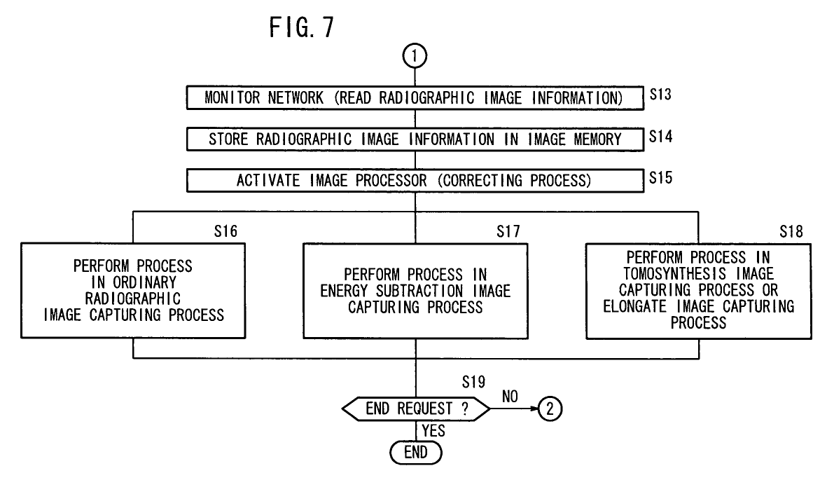

In step S13, as shown in FIG. 7, the network monitor unit 164 (see FIG. 5) monitors the wireless LAN 18 and reads the radiographic image information Da, which is transmitted via the wireless LAN 18 from the first image capturing apparatus 12A to the first console 14A.

In step S14, the data storage unit 166 (see FIG. 5) stores the radiographic image information Da, which corresponds to the attribute (number information) of the supplied one of the first image processing command signal Sd1 through the third image processing command signal Sd3, in the image memory 154.

More specifically, in the ordinary radiographic image capturing process, the first image processing command signal Sd1 is input to either one of the second through fourth consoles 14B through 14D in order to instruct the console to perform an image processing process. The data storage unit 166 of the instructed console stores one item of radiographic image information Da in the image memory 154 thereof.

In the energy subtraction image capturing process, the second image processing command signal Sd2 is input to one or two consoles of the second through fourth consoles 14B through 14D in order to instruct the console or consoles to perform an image processing process. If the second image processing command signal Sd2 is input to only one of the second through fourth consoles 14B through 14D, then the data storage unit 166 of the instructed console stores two items of radiographic image information Da in the image memory 154 thereof. If the second image processing command signal Sd2 is input to two of the second through fourth consoles 14B through 14D (e.g., the second console 14B and the third console 14C), then the data storage unit 166 of the second console 14B stores the first item of radiographic image information Da in the image memory 154 thereof, whereas the data storage unit 166 of the third console 14C stores the second item of radiographic image information Da in the image memory 154 thereof.

In the tomosynthesis image capturing process or the elongate image capturing process, the third image processing command signal Sd3 is input to either one, two, or three of the second through fourth consoles 14B through 14D in order to instruct one or more of the second through fourth consoles to perform an image processing process. If the third image processing command signal Sd3 is input to only one of the second through fourth consoles 14B through 14D, then the data storage unit 166 of the instructed console stores all items of radiographic image information Da in the image memory 154. If the third image processing command signal Sd3 is input to two (e.g., the second console 14B and the third console 14C) of the second through fourth consoles 14B through 14D, then the data storage unit 166 of the second console 14B stores odd-numbered items of radiographic image information Da in the image memory 154, while the data storage unit 166 of the third console 14C stores even-numbered items of radiographic image information Da in the image memory 154. If the third image processing command signal Sd3 is input to three consoles (e.g., the second through fourth consoles 14B through 14D), then the data storage unit 166 of the second console 14B stores the (3n+1)th item of radiographic image information Da in the image memory 154, the data storage unit 166 of the third console 14C stores the (3n+2)th item of radiographic image information Da in the image memory 154, and the data storage unit 166 of the fourth console 14D stores the (3n+3)th item of radiographic image information Da in the image memory 154.

When storage of the radiographic image information Da in the image memory 154 by the data storage unit 166 is completed, the first image processing activator 168 activates the image processor 156. The image processor 156 performs a corrective process on the radiographic image information Da stored in the image memory 154.

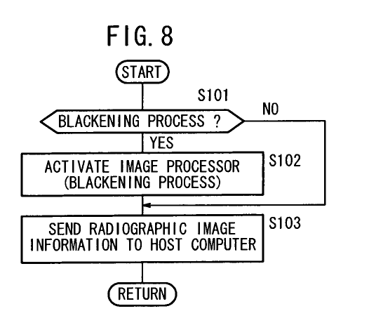

Subsequently, different processing sequences take place in the ordinary radiographic image capturing process, the energy subtraction image capturing process, the tomosynthesis image capturing process, and the elongate image capturing process. More specifically, in the ordinary radiographic image capturing process, control proceeds to step S16 in order to process the radiographic image information Da captured in the ordinary radiographic image capturing process. In step S101 shown in FIG. 8, the console determines whether or not a blackening process is required, based on whether the specification information includes a command for a blackening process. If it is judged that a blackening process is required, then control proceeds to step S102, in which the second image processing activator 174 activates the image processor 156. The image processor 156 performs a blackening process based on the specification information concerning the corrected radiographic image information Da stored in the image memory 154.

If it is judged that a blackening process is not required in step S101, or when the process of step 5102 is completed, control proceeds to step S103, at which point the image transmitter 158 sends the processed radiographic image information dDa, i.e., the corrected radiographic image information stored in the image memory 154 or the radiographic image information processed by the blackening process, to the host computer 22.

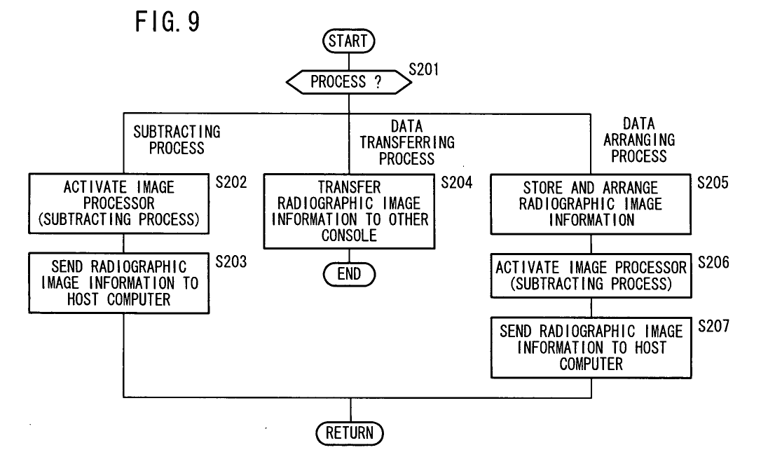

In the energy subtraction image capturing process, control proceeds to step S17 (see FIG. 7) in order to process the radiographic image information Da captured during the energy subtraction image capturing process. In step S201 shown in FIG. 9, the support processing system 144 determines whether a subtracting process, a data transferring process, or a data arranging process is required. If the number information sent along with the second image processing command signal Sd2 from the host computer 22 is “0”, then the support processing system 144 judges that a subtracting process is required. If the number information is something other than “0” and the ID sent along with the second image processing command signal Sd2 is not the ID of the console itself, then the support processing system 144 judges that a data transferring process is required. If the number information is something other than “0” and the ID sent along with the second image processing command signal Sd2 is the ID of the console itself, then the support processing system 144 judges that a data arranging process is required.

If the support processing system 144 judges that a subtracting process is required, then control proceeds to step S202, in which the second image processing activator 174 activates the image processor 156. The image processor 156 performs a subtracting process on the two corrected items of radiographic image information eDa stored in the image memory 154, thereby generating an energy subtraction image.

Thereafter, in step S203, the image transmitter 158 sends the energy subtraction image stored in the image memory 154, i.e., the processed radiographic image information dDa, to the host computer 22.

If the support processing system 144 judges that a data transferring process is required in step S201, then control proceeds to step S204, in which the data transfer unit 170 transfers one of the corrected items of radiographic image information eDa to the console that corresponds to the ID sent along with the second image processing command signal Sd2. When transfer of the radiographic image information eDa by the data transfer unit 170 has been completed, the processing sequence by the console ends.

If the support processing system 144 judges that a data arranging process is required in step S201, then control proceeds to step S205, in which the data arranger 172 receives one corrected item of radiographic image information eDa transferred from another console, stores the received corrected item of radiographic image information eDa in the image memory 154, and arranges the transferred radiographic image information eDa in chronological order along with the radiographic image information eDa corrected in the console itself.

Then, in step S206, the second image processing activator 174 activates the image processor 156. The image processor 156 performs a subtracting process on the two corrected items of radiographic image information eDa stored in the image memory 154, thereby generating an energy subtraction image.

Thereafter, in step S207, the image transmitter 158 sends the energy subtraction image stored in the image memory 154, i.e., the processed radiographic image information dDa, to the host computer 22.

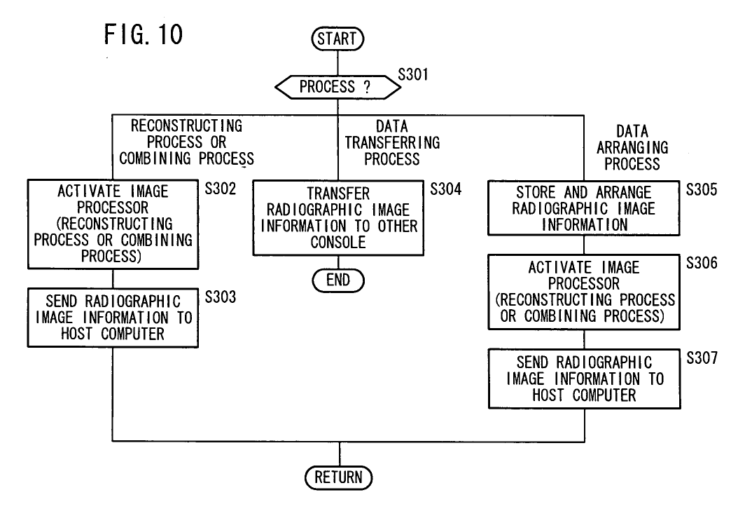

In the tomosynthesis image capturing process or the elongate image capturing process, control proceeds to step S18 (see FIG. 7) in order to process the radiographic image information Da captured in the tomosynthesis image capturing process or in the elongate image capturing process. In step S301, as shown in FIG. 10, the support processing system 144 determines whether a reconstructing process, a data transferring process, or a data arranging process is required. If the number information sent along with the third image processing command signal Sd3 from the host computer 22 is “0”, then the support processing system 144 judges that a reconstructing process is required. If the number information is something other than “0” and the ID sent along with the third image processing command signal Sd3 is not the ID of the console itself, then the support processing system 144 judges that a data transferring process is required. If the number information is something other than “0” and the ID sent along with the second image processing command signal Sd2 is the ID of the console itself, then the support processing system 144 judges that a data arranging process is required.

If the support processing system 144 judges that a reconstructing process or a combining process is required, then control proceeds to step S302, in which the second image processing activator 174 activates the image processor 156. The image processor 156 performs a reconstructing process or a combining process on all of the corrected items of radiographic image information eDa stored in the image memory 154, thereby generating a tomographic image of the region of interest included within the specification information, or a wide radiographic image of the spine or the like.

Thereafter, in step S303, the image transmitter 158 sends the tomographic image stored in the image memory 154, i.e., the processed radiographic image information dDa, to the host computer 22.

If the support processing system 144 judges that a data transferring process is required in step S301, then control proceeds to step S304, in which the data transfer unit 170 transfers the corrected radiographic image information eDa along with the number information to the console that corresponds to the ID sent along with the third image processing command signal Sd3. When transfer of the radiographic image information eDa by the data transfer unit 170 has been completed, the processing sequence of the console ends.

More specifically, if the number of consoles is “2”, then the data transfer unit 170 transfers the corrected radiographic image information eDa stored in the image memory 154, i.e., even-numbered items of radiographic image information eDa, to the console.

If the number of consoles is “3” and the number information represents “2”, then the data transfer unit 170 transfers the corrected radiographic image information Da stored in the image memory 154, i.e., the (3n+2)th item of radiographic image information eDa, to the console. If the number of consoles is “3” and the number information represents “3”, then the data transfer unit 170 transfers the corrected radiographic image information eDa stored in the image memory 154, i.e., the (3n+3)th item of radiographic image information eDa, to the console. In other words, if the number of consoles is “A” and the number information represents “m”, then the data transfer unit 170 transfers the corrected radiographic image information eDa stored in the image memory 154, i.e., the (An+m)th item of radiographic image information eDa, to the console.

When transfer of the radiographic image information eDa by the data transfer unit 170 has been completed, the processing sequence of the console ends.

If the support processing system 144 judges that a data arranging process is required in step S301, then control proceeds to step S305, in which the data arranger 172 receives a number of corrected items of radiographic image information eDa, which are transferred along with number information and console IDs from the other consoles, stores the received corrected items of radiographic image information eDa in the image memory 154, and arranges the transferred radiographic image information eDa in chronological order along with the radiographic image information eDa corrected in the console itself, based on the number information and console IDs.

Then, in step S306, the second image processing activator 174 activates the image processor 156. The image processor 156 performs a reconstruction process or a combining process on all of the corrected items of radiographic image information eDa that are stored in the image memory 154, thereby generating a tomographic image of the region of interest included within the specification information, or a wide radiographic image of the spine or the like.

Thereafter, in step S307, the image transmitter 158 sends the tomographic image stored in the image memory 154, i.e., the processed radiographic image information dDa, to the host computer 22.

When the processing sequence with respect to the ordinary radiographic image capturing process (step S16), the processing sequence with respect to the energy subtraction image capturing process (step S17), or the processing sequence with respect to the tomosynthesis image capturing process or the elongate image capturing process (step S18) has been completed, control proceeds to step S19, in which the host computer 22 determines whether or not there is an end request, i.e., a request to turn off the power supply, a request for maintenance, or the like. If there is no end request, then the processing operation from step S1 shown in FIG. 6 is repeated. If there is an end request, then the processing operation of the first system 10A is brought to an end.

In the first system 10A, as described above, when one of the image capturing apparatus, e.g., the first image capturing apparatus 12A, is specified based on patient information and image capture command information, one of the first through fourth consoles 14A through 14D, e.g., the first console 14A, controls the specified image capturing apparatus, whereas one or more of the other consoles performs an image processing process. Therefore, the first console 14A functions as an image capture control apparatus for controlling the image capturing apparatus, whereas one or more of the other consoles functions as an image processing apparatus for performing an image processing process on the radiographic image information from the image capturing apparatus. In other words, the first system 10A acts to distribute functions among the first through fourth consoles 14A through 14D.

Consequently, irrespective of whether the image capturing apparatus controlled by the first console 14A performs an energy subtraction image capturing process, a tomosynthesis image capturing process, or an elongate image capturing process, the first console 14A is made available for use immediately after control thereby over the image capturing apparatus is finished, and hence, the time required to wait for the first console 14A is extremely short. As a result, after having completed control over the image capturing apparatus, the first console 14A can immediately control the image capturing apparatus to perform a subsequent image capturing process, and hence the image capturing apparatus can be operated highly efficiently. According to the first embodiment, therefore, a simplified schedule management is possible for a system including a single image capturing apparatus, as well as for a system including various image capturing apparatus connected in a complex layout.

In the above illustrated embodiment, using the priority table 120, the image processing commander 112 of the host computer 22 selects one or more consoles to be used for processing the radiographic image information, from among one or more consoles other than the console to which the image capture control command signal Sc has been supplied. Alternatively, using the priority table 120, the image processing commander 112 may select two or more consoles to be used for processing the radiographic image information, from among two or more consoles other than the console to which the image capture control command signal Sc has been supplied. According to the alternative, the image receiver 150 of the console to which the image capture control command signal Sc has been supplied, e.g., the first console 14A, stores the radiographic image information Da received from the image capturing apparatus in the image memory 154, and also processes the received radiographic image information Da.

According to the alternative, therefore, one of the first through fourth consoles 14A through 14D (e.g., the first console 14A) controls the image capturing apparatus, and two or more consoles including the first console 14A perform an image processing process. In other words, two or more consoles including the first console 14A function as an image processing apparatus, for processing the radiographic image information Da from the image capturing apparatus. Hence, the load distribution for image processing is carried out among the first through fourth consoles 14A through 14D.

Since an image processing process, which heretofore has been performed by one console, can be carried out by two or more consoles, the time required for the image processing process to be carried out can be shorter, and hence, the waiting time for a desired console is greatly reduced. As a result, the first console 14A, after having completed its control over the image capturing apparatus, can immediately be used to control the image capturing apparatus efficiently during a subsequent image capturing process. Accordingly, a simplified schedule management is possible for a system including a single image capturing apparatus, as well as for a system including various image capturing apparatus connected in a complex layout.

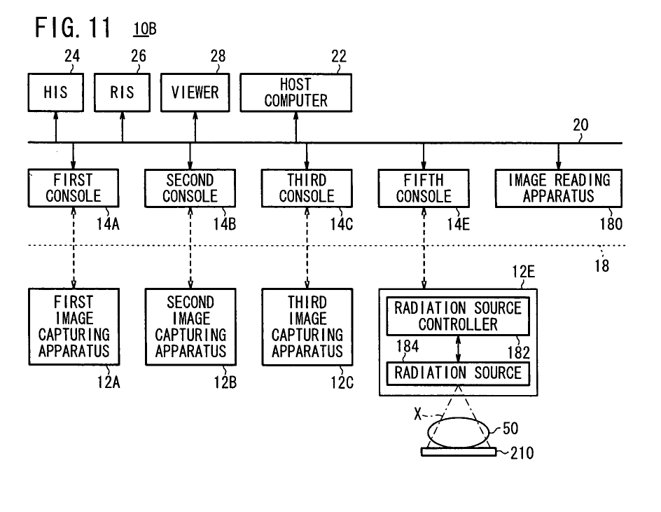

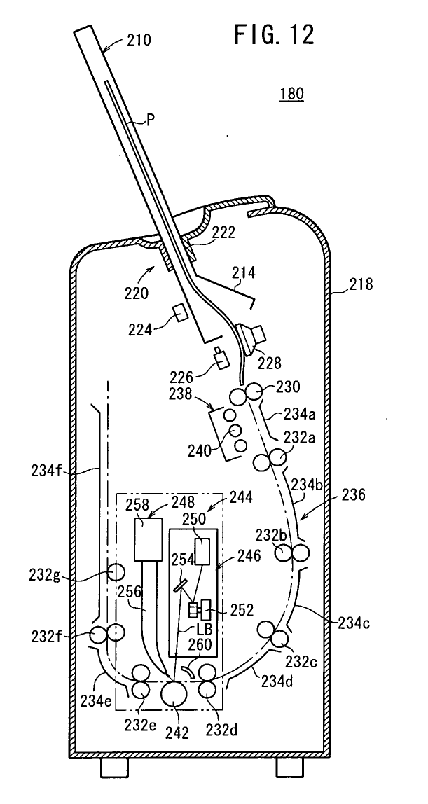

A radiographic image capturing system according to a second embodiment of the present invention (hereinafter referred to as a “second system 10B”) will be described below with reference to FIGS. 11 and 12.

As shown in FIG. 11, the second system 10B is substantially similar in configuration to the first system 10A, but differs therefrom in that the second system 10B includes a fifth console 14E, a fifth image capturing apparatus 12E, and an image reading apparatus 180 for reading radiographic image information Da captured by the fifth image capturing apparatus 12E, all of which are connected to the wireless LAN 18, instead of the fourth console 14D and the fourth image capturing apparatus 12D shown in FIG. 1. The fifth console 14E and the image reading apparatus 180 also are connected to the wired LAN 20.

The fifth image capturing apparatus 12E is a recumbent image capturing apparatus for capturing a radiographic image of a wide area, e.g., the chest or the like, of a subject 50. The fifth image capturing apparatus 12E comprises a radiation source 184 controlled by a radiation source controller 182, and an image capturing bed disposed in confronting relation to the radiation source 184. The image capturing bed has a slot (not shown) defined in a side wall thereof, for example, for inserting a cassette 210, which houses a stimulable phosphor panel P therein (see FIG. 12). The radiation source controller 182 controls the radiation source 184 according to image capturing conditions set by the fifth console 14E.

The stimulable phosphor panel P comprises a stimulable phosphor layer for storing the energy of radiation X applied thereto, and a support on which the stimulable phosphor layer is disposed. When the stimulable phosphor panel P is irradiated with stimulating light, the stimulable phosphor panel P emits stimulated light the intensity of which is proportional to the stored energy. After the stimulable phosphor panel P has emitted stimulated light, any remaining energy left in the stimulable phosphor panel P can be removed when the stimulable phosphor panel P is irradiated with a given amount of erasing light, thereby enabling the stimulable phosphor panel P to be reused.

Radiographic image information Da recorded in the stimulable phosphor panel P is read by the image reading apparatus 180, which has a structure as shown in FIG. 12. The image reading apparatus 180 and the fifth image capturing apparatus 12E are controlled by the fifth console 14E.

As shown in FIG. 12, the image reading apparatus 180 includes a cassette loader 220 disposed in an upper portion of a casing 218, and a display panel (not shown) also disposed in the upper portion of the casing 218, for displaying information required in an image reading process carried out by the image reading apparatus 180. The cassette loader 220 has a loading slot 222 for receiving a cassette 210, which houses therein a stimulable phosphor panel P with recorded radiation image information. Near the loading slot 222, the casing 218 accommodates therein a bar-code reader 224 for reading identification information recorded in a bar code on the cassette 210, an unlocking mechanism 226 for unlocking a lid 214 of the cassette 210, a suction cup 228 for attracting and removing the stimulable phosphor panel P from the cassette 210 when the lid 214 is opened, and a pair of nip rollers 230 for gripping and feeding the stimulable phosphor panel P removed by the suction cup 228.

The nip rollers 230 are followed by a plurality of feed rollers 232a through 232g and a plurality of guide plates 234a through 234f, which jointly make up a curved feed path 236. The curved feed path 236 extends downwardly from the cassette loader 220, extends substantially horizontally at a lowermost portion thereof, and then extends substantially vertically upward. A curved feed path 236 of this shape is effective in making the image reading apparatus 180 small in size.

An erasing unit 238 is disposed between the nip rollers 230 and the feed rollers 232a, for erasing radiation radiographic image information remaining in the stimulable phosphor panel P, from which desired radiographic image information has already been read. The erasing unit 238 has a plurality of erasing light sources 240 such as cold cathode-ray tubes or the like for emitting erasing light.

A platen roller 242 is disposed between the feed rollers 232d, 232e, which are positioned in the lowermost portion of the curved feed path 236. The platen roller 242 is disposed beneath a scanning unit 244 for reading desired radiographic image information recorded in the stimulable phosphor panel P.

The scanning unit 244 comprises a stimulator 246 for emitting a laser beam LB as stimulating light to scan the stimulable phosphor panel P, and a reader 248 for reading stimulated light emitted from the stimulable phosphor panel P, which is stimulated by the laser beam LB.

The stimulator 246 comprises a laser oscillator 250 that outputs the laser beam LB, a rotary polygon mirror 252 for deflecting the laser beam LB in a main scanning direction across the stimulable phosphor panel P, and a reflecting mirror 254 for reflecting the laser beam LB toward the stimulable phosphor panel P as the stimulable phosphor panel P passes over the platen roller 242.

The reader 248 comprises a light guide 256 having a lower end disposed near the stimulable phosphor panel P over the platen roller 242, and a photomultiplier 258 connected to an upper end of the light guide 256, for converting stimulated light from the stimulable phosphor panel P into an electric signal, which represents the radiographic image information stored in the stimulable phosphor panel P. A light collecting mirror 260 for collecting stimulated light from the stimulable phosphor panel P is disposed near the lower end of the light guide 256. The photomultiplier 258 supplies an electric signal representing the radiographic image information to the host computer 22 via the wired LAN 20.

As with the first through third consoles 14A through 14C, each of the fifth console 14E and the image reading apparatus 180 includes therein the image capture control system 140, the image processing system 142, and the support processing system 144.

The second system 10B thus constructed is capable of distributing functions and loads among the consoles, in the same manner as the first system 10A, thus allowing the image capturing apparatus to be operated efficiently. According to the second embodiment, therefore, a simplified schedule management also is possible for a system including a single image capturing apparatus, as well as for a system including various image capturing apparatus connected in a complex layout.

The radiographic image capturing system and the radiographic image capturing method according to the present invention are not limited to the various embodiments described above, and various changes and modifications may be made to the embodiments within the scope of the present invention.

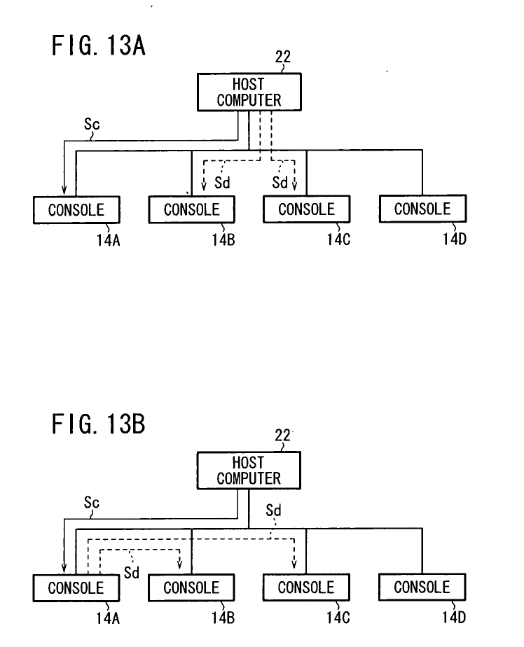

According to the first embodiment, as schematically shown in FIG. 13A, since the host computer 22 incorporates therein the image capture control commander 110 and the image processing commander 112, the image capture control commander 110 outputs an image capture control command signal Sc to one console, e.g., the first console 14A, whereas the image processing commander 112 outputs image processing command signals Sd, respectively, to a plurality of consoles, e.g., the second console 14B and the third console 14C.

According to a first modification, as schematically shown in FIG. 13B, each of the consoles includes an image processing commander 112. The image capture control commander 110 of the host computer 22 outputs an image capture control command signal Sc to one console, e.g., the first console 14A, whereas the image processing commander 112 of the first console 14A outputs image processing command signals Sd, respectively, to a plurality of consoles, e.g., the second console 14B and the third console 14C.

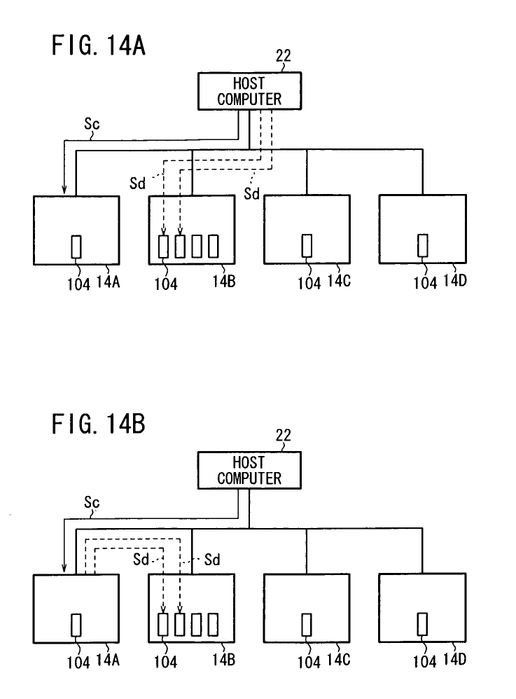

According to a second modification, as schematically shown in FIG. 14A, at least one image processing board 104, serving as an image processing unit and including an image memory 154 and an image processor 156, is incorporated in each of the consoles. At least one of the consoles, e.g., the second console 14B, incorporates a plurality of image processing boards 104 therein. The image capture control commander 110 of the host computer 22 outputs an image capture control command signal Sc to one console, e.g., the first console 14A, and the image processing commander 112 of the host computer 22 outputs image processing command signals Sd respectively to each of the image processing boards 104 of the second console 14B. Each of the consoles may include a plurality of image processing boards 104.

According to a third modification, as schematically shown in FIG. 14B, each of the consoles has an image processing commander 112 and at least one image processing board 104. At least one of the consoles, e.g., the second console 14B, incorporates a plurality of image processing boards 104 therein. The image capture control commander 110 of the host computer 22 outputs an image capture control command signal Sc to one console, e.g., the first console 14A, and the image processing commander 112 of the first console 14A outputs image processing command signals Sd respectively to the image processing boards 104 of the second console 14B. Each of the consoles may include a plurality of image processing boards 104.

The radiation detector 70 according to the first embodiment is of the direct conversion type, which directly converts the dose of applied radiation X into an electric signal with the photoelectric conversion layer 51. However, each of the image capturing apparatus may employ a radiation detector of an indirect conversion type including a scintillator for converting the applied radiation X into visible light, and a solid-state detecting device made up of amorphous silicon (a-Si) or the like for converting the visible light into electric signals (see Japanese Patent No. 3494683).

Although certain preferred embodiments of the present invention have been shown and described in detail, it should be understood that various changes and modifications may be made to the embodiments without departing from the scope of the invention as set forth in the appended claims.

What is claimed is:

1. A radiographic image capturing system comprising:
at least one image capturing apparatus for detecting radiation that has passed through a subject in a radiographic image capturing process and converting the detected radiation into radiographic image information;
one or more controllers for controlling the image capturing apparatus based on image capture command information;
a plurality of image processors for performing an image processing process to process the radiographic image information from the image capturing apparatus;
an image capture control commanding unit for outputting an image capture control command signal to one of the controllers to enable the one of the controllers to control the image capturing apparatus; and
an image processing commanding unit for outputting an image processing command signal to at least one of the image processors to enable the at least one of the image processors to perform the image processing process to process the radiographic image information from the image capturing apparatus.

2. A radiographic image capturing system according to claim 1, wherein the image processors are incorporated respectively in the controllers; and
the image processing commanding unit outputs the image processing command signal to at least one of the controllers to enable the at least one of the controllers to perform the image processing process to process the radiographic image information from the image capturing apparatus.

3. A radiographic image capturing system according to claim 1, wherein the image processors are incorporated respectively in the controllers; and
the image processing commanding unit outputs the image processing command signal to at least another one of the controllers, other than the one of the controllers that is supplied with the image capture control command signal.

4. A radiographic image capturing system according to claim 1, wherein the image processors are incorporated respectively in the controllers; and
the image processing commanding unit outputs the image processing command signal to at least another two of the controllers, other than the one of the controllers that is supplied with the image capture control command signal.

5. A radiographic image capturing system according to claim 4, wherein the image processing commanding unit instructs at least one of the controllers that are supplied with the image processing command signal, to perform the image processing process to process at least one of a plurality of items of the radiographic image information from the image capturing apparatus, and instructs at least another one of the controllers that are supplied with the image processing command signal, to perform the image processing to process at least another one of the plurality of items of the radiographic image information from the image capturing apparatus.

6. A radiographic image capturing system according to claim 1, wherein the image processors are incorporated respectively in the controllers; and
the image processing commanding unit outputs the image processing command signal to the one of the controllers that is supplied with the image capture control command signal and to at least another one of the controllers.

7. A radiographic image capturing system according to claim 6, wherein the image processing commanding unit instructs at least one of the controllers that are supplied with the image processing command signal, to perform the image processing process to process at least one of a plurality of items of the radiographic image information from the image capturing apparatus, and instructs at least another one of the controllers that are supplied with the image processing command signal, to perform the image processing process to process at least another one of the plurality of items of the radiographic image information from the image capturing apparatus.

8. A radiographic image capturing system according to claim 1, wherein the image processors are incorporated in at least one of the controllers; and
the image processing commanding unit outputs the image processing command signal to at least one of the image processors incorporated in the at least one of the controllers to enable the at least one of the image processors to perform the image processing process to process the radiographic image information from the image capturing apparatus.

9. A radiographic image capturing system according to claim 1, wherein the image processing process performed by the at least one of the image processors includes at least one of:
(1) a correcting process to be carried out on the radiographic image information from the image capturing apparatus;
(2) a blackening process to be carried out on the radiographic image information from the image capturing apparatus;
(3) a subtracting process to be carried out on two items of the radiographic image information from an energy subtraction image capturing apparatus included in the at least one image capturing apparatus;
(4) a process of generating a tomographic image from a plurality of items of the radiographic image information from a tomosynthesis image capturing apparatus included in the at least one image capturing apparatus; and
(5) a process of combining a plurality of items of the radiographic image information from an elongate image capturing apparatus included in the at least one image capturing apparatus into a radiographic image representative of an elongate area of the subject.

10. A radiographic image capturing system according to claim 1, wherein the at least one image capturing apparatus comprises an energy subtraction image capturing apparatus;
the image processing process performed by the image processors that are supplied with the image processing command signal, comprises a correcting process to be carried out on a plurality of items of the radiographic image information from the image capturing apparatus; and
at least one of the image processors performs a subtracting process on the plurality of items of the radiographic image information on which the correcting process has been carried out.

11. A radiographic image capturing system according to claim 1, wherein the at least one image capturing apparatus comprises a tomosynthesis image capturing apparatus;
the image processing process performed by the image processors that are supplied with the image processing command signal, comprises a correcting process to be carried out on a plurality of items of the radiographic image information from the image capturing apparatus; and
at least one of the image processors performs a process of generating a tomographic image based on the plurality of items of the radiographic image information on which the correcting process has been carried out.

12. A radiographic image capturing system according to claim 1, wherein the at least one image capturing apparatus comprises an elongate image capturing apparatus;
the image processing process performed by the image processors that are supplied with the image processing command signal, comprises a correcting process to be carried out on a plurality of items of the radiographic image information from the image capturing apparatus; and
at least one of the image processors performs a process of combining the plurality of items of the radiographic image information on which the correcting process has been carried out, into a radiographic image representative of an elongate area of the subject.

13. A radiographic image capturing method to be carried out by a radiographic image capturing system including at least one image capturing apparatus for detecting radiation that has passed through a subject in a radiographic image capturing process and converting the detected radiation into radiographic image information, one or more controllers for controlling the image capturing apparatus based on image capture command information, and a plurality of image processors for performing an image processing process to process the radiographic image information from the image capturing apparatus, the radiographic image capturing method comprising the steps of:
outputting an image capture control command signal to one of the controllers to enable the one of the controllers to control the image capturing apparatus; and
outputting an image processing command signal to at least one of the image processors to enable the at least one of the image processors to perform the image processing process to process the radiographic image information from the image capturing apparatus.

14. A radiographic image capturing method according to claim 13, wherein the image processing process performed by the at least one of the image processors includes at least one of:
(1) a correcting process to be carried out on the radiographic image information from the image capturing apparatus;
(2) a blackening process to be carried out on the radiographic image information from the image capturing apparatus;
(3) a subtracting process to be carried out on two items of the radiographic image information from an energy subtraction image capturing apparatus included in the at least one image capturing apparatus;
(4) a process of generating a tomographic image from a plurality of items of the radiographic image information from a tomosynthesis image capturing apparatus included in the at least one image capturing apparatus; and
(5) a process of combining a plurality of items of the radiographic image information from an elongate image capturing apparatus included in the at least one image capturing apparatus into a radiographic image representative of an elongate area of the subject.
